(19) United States
(12) Patent Application Publication
(10) Pub. No.: US 2014/0218935 A1
(43) Pub. Date: Aug. 7, 2014

(54) Illumination Unit with Optical System

(71) Applicants: Herbert Weiss, Diedorf (DE); Sergey Kudaev, Ingolstadt (DE); Tobias Frunder, Augsburg (DE)

(72) Inventors: Herbert Weiss, Diedorf (DE); Sergey Kudaev, Ingolstadt (DE); Tobias Frunder, Augsburg (DE)

(73) Assignee: OSRAM GMBH, Muenchen (DE)

(21) Appl. No.: 14/241,501

(22) PCT Filed: Aug. 30, 2012
(86) PCT No.: PCT/EP2012/066872

§ 371 Date: Feb. 27, 2014

(30) Foreign Application Priority Data
Sep. 2, 2011 (DE) 10 2011 112 222.6

(51) Int. Cl. F21V 7/00; F21V 13/10; G02B 27/10; F21K 99/00

(52) U.S. Cl. CPC F21V 7/0033; F21K 9/50; F21V 13/10; G02B 27/1006
USPC 362/300; 362/298

(57) ABSTRACT

Various embodiments of the illumination unit include a surface light source, a primary optical element, a first reflector and a second reflector. The primary optical element is arranged at the surface light source in such a way that light emitted by the surface light source is imaged onto the first reflector by the primary optical element. The beam cross section of the light is reduced by the primary optical element at the same time. In this case, the first reflector images the light beam that has been reduced by means of the primary optical element onto the second reflector in order to emit the light from the second reflector from the illumination unit.

This patent application is a national phase filing under section 371 of PCT/EP2012/066872, filed Aug. 30, 2012, which claims the priority of German patent application 10 2011 112 222.6, filed Sep. 2, 2011, each of which is incorporated herein by reference in its entirety.

### TECHNICAL FIELD

The present invention relates to an illumination unit comprising a light source and an optical system containing an optical waveguide arrangement and reflector arrangement.

### BACKGROUND

An illumination unit is known from International Patent Publication No. WO 2008/017968 A2, which discloses an illumination unit containing a semiconductor light source, a primary optical system and a secondary optical system. The primary optical system guides the light from the semiconductor light source onto the secondary optical system. The secondary optical system emits the light in a desired beam pattern. Owing to the geometrically narrowly delimited area of the light source, only a small quantity of light is introduced into the illumination unit via the primary optical system. Consequently, an illumination unit of this type achieves a low axial light intensity.

### SUMMARY OF THE INVENTION

The present invention addresses the problem of providing an illumination unit comprising a surface light source in which the axial light intensity customary from a conventional reflector halogen incandescent lamp is achieved with at the same time a narrow emission angle.

Various embodiments of the illumination unit comprise a surface light source, a primary optical element, a first reflector and a second reflector. The primary optical element is arranged at a surface light source in such a way that light emitted by the surface light source is imaged onto the first reflector by the primary optical element, the beam cross section of the light being reduced by the primary optical element at the same time. The first reflector images the light beam that has been reduced by means of the primary optical element onto the second reflector in order to emit the light from the second reflector from the illumination unit.

The primary optical element that reduces the beam cross section makes it possible to use a surface light source having larger dimensions, for example, a large-area light-emitting diode (LED) module. Such surface light sources having large dimensions emit a multiple luminous flux compared with a customary LED or with an LED module having small dimensions. Through geometrical adaptation of the surface light source, it is thus possible to obtain a luminous flux comparable with a conventional light source such as, e.g., a halogen incandescent lamp.

A luminous flux is directed onto the reflector arrangement via the primary optical element. The reflector arrangement comprises a first and a second reflector. The luminous flux is emitted from the illumination unit via the reflector arrangement, as a result of which the axial light intensity customary from a conventional illumination unit is achieved.

Some embodiments of the illumination unit contain, as the surface light source, a light-emitting semiconductor component or a module having a plurality of light-emitting semiconductor components. Such semiconductor components can be, for example, light-emitting diodes (LEDs), organic light-emitting diodes (OLEDs) or else laser diodes (LDs). Organic light-emitting electrochemical cells (OLEECs) would also be suitable as the surface light source.

The light-emitting semiconductor components can emit in each case single-colored light (for example, in the colors red, green, blue, etc.), or mixed light (for example, white). A plurality of light-emitting semiconductor components can generate mixed light; e.g., white mixed light.

As the temperature increases, a light-emitting semiconductor component loses efficiency and degrades earlier. Good dissipation of heat from the light-emitting semiconductor components is therefore sought. Besides cooling devices, the local temperature distribution at the semiconductor component plays an important part. The use of a surface light source having large dimensions proves to be advantageous. This is because the luminous flux required for the illumination unit is generated on a larger area. The heat that arises in this case is distributed over a larger area, as a result of which the individual semiconductor components are subjected to lower thermal loading and degrade more slowly.

In one embodiment, the surface light source is fitted outside the reflector arrangement. In this case, the surface light source has larger dimensions than or the same dimensions as an opening in the vertex region of the second reflector. Through said opening, the light from the surface light source is guided into the reflector arrangement by means of the primary optical element, thereby enabling a high luminous flux to be coupled into the reflector arrangement with at the same time good dissipation of heat from the surface light source.

In a further embodiment, the surface light source is a directional light source. In this case, the majority of the emitted light is emitted in a preferred direction, for example, perpendicular to the surface light source. In order that the light emitted by the surface light source is coupled into the primary optical element in a manner as free of losses as possible, the emission angle of the directional surface light source is limited to 80° FWHM. In this case, the emission angle is indicated with the full width at half maximum (FWHM).

The semiconductor components can contain optical elements which concentrate the light in the emission direction. Such optical elements can be attachment lenses. Alternatively, the semiconductor components themselves can contain curved surfaces which concentrate the emitted light in the preferred direction.

Various embodiments contain a primary optical element having a conical element as light concentrator. The conical element can be a conical optical waveguide, for example, the light entrance area of which is greater than the light exit area thereof. The area ratio of entrance area to exit area should be at least 2:1, better still at least 9:1. The conical optical waveguide can be a hollow body having a conical lateral surface. One element that is technically easy to realize is a conical metal ring. Ideally, the inner side of the conical lateral surface is reflectively fashioned or provided with a reflective coating.

Alternatively, the conical optical waveguide can consist of a transparent material such as glass or Plexiglas. In addition, the light entrance area of the conical optical waveguide can contain cutouts into which the light-emitting semiconductor components of the surface light source project. These depressions enable the light emitted by the surface light source to be coupled into the primary optical element with low losses.

In further embodiments, the primary optical element contains a linear optical waveguide, which is adjacent to the exit opening of the conical element. The linear optical waveguide can be, for example, a cylindrical glass rod or cylindrical Plexiglas rod. The linear optical waveguide can alternatively consist of a metal tube, the inner side of which is reflectively fashioned or provided with a reflective layer. The optical waveguide guides the light concentrated by the conical element in the direction of the first reflector.

In some embodiments, the first reflector is situated in an extension of the optical axis and conceals the exit area of the primary optical element. The optical axis is perpendicular to the surface light source and extends axially symmetrically through the illumination unit. The light emitted by the primary optical element is directed back onto the second reflector by the first reflector. The second reflector deflects the light beam from the illumination unit near the axis. Lateral emission from the illumination unit is suppressed, whereby glare perpendicular to the optical axis is avoided.

In some embodiments, an axicon-shaped mirror is used as the first reflector. An axicon-shaped minor is a rotationally symmetrical minor having a conically extending mirror surface which images a circular light point into a circular light ring. The axicon-shaped mirror completely deflects the light beam emitted by the primary optical element onto the second reflector.

In some embodiments, the second reflector is a parabolic minor, the vertex region of which contains an opening, through which the primary optical element projects into the illumination unit. The beams reflected by the axicon-shaped mirror form an annular light distribution corresponding to the dimensioning of the second reflector. Light losses owing to lateral emission are avoided. Lateral emission would mean light beams which led past within the inner annulus or outside the outer annulus of the second reflector. Ideally, the area of the second reflector is illuminated homogeneously by the reflection at the axicon-shaped mirror.

The second reflector generates in the plane of the first reflector an annular light distribution, the internal diameter of which is greater than or equal to the diameter of the first reflector. The light beams are guided past at the first reflector without light losses owing to shading at the first reflector. By means of geometrical adaptation of the first reflector and second reflector, it is thus possible to achieve a light distribution near the axis without shading losses. The emission angle of the illumination unit is less than 10° FWHM.

If the surface light source contains multicolored LEDs, the lateral surface of the primary optical element or the surface of the second reflector can be faceted for the purpose of color homogenization. The facet dimensions of the second reflector are not greater than the light-emitting area of the individual LEDs.

In further embodiments, the illumination unit comprises a transparent cover, which encloses the reflector arrangement. The transparent cover protects the illumination unit against ingress of dust or dirt and prevents corrosion of the optical components. The transparent cover can be fixed to the second reflector, for example, by a thread or a snap-action device.

In one embodiment, the first reflector is fixed to the transparent cover, such that the first reflector is connected to the second reflector via the transparent cover. This embodiment obviates mechanical components which hold the first reflector in defined positions with respect to the primary optical element and the second reflector. This precludes light losses owing to shading at the mechanical components which otherwise lie in the beam path of the reflector arrangement.

The transparent cover can contain a light-scattering structure having a scattering angle range of preferably 2° to 4° FWHM. A light distribution that is more homogenous in the far field is obtained as a result. In this case, the transparent cover can comprise a material having a light-scattering structure. Alternatively, the transparent cover can also comprise a material having high optical transparency such as glass or Plexiglas, for example, wherein a surface contains a light-scattering structure.

In a further embodiment, the transparent cover contains a color-mixing structure, as a result of which, in particular, a better color homogeneity in the far field is achieved. This has an advantageous effect in particular in terms of the color homogeneity if the surface light source contains light-emitting diodes with multicolored emission or light-emitting diodes with different-colored mixed light such as warm-white or cold-white, for example.

### BRIEF DESCRIPTION OF THE DRAWINGS

Various exemplary embodiments of the illumination unit are explained in greater detail below with reference to the drawings. In the figures, the first digit(s) of a reference sign indicate the figure in which the reference sign is first used. Identical reference signs are used for elements and/or properties that are of identical type or act identically in all the figures.

FIG. 1 shows a schematic cross-sectional illustration through a first exemplary embodiment of an illumination unit;

FIG. 2 shows a schematic cross-sectional illustration of the primary optical element;

FIG. 3 shows a further schematic cross-sectional illustration of the primary optical element;

FIG. 4 shows a schematic cross-sectional illustration of the reflector arrangement; and

FIG. 5 shows a schematic cross-sectional illustration through a second exemplary embodiment of an illumination unit with a transparent cover.

### DETAILED DESCRIPTION OF ILLUSTRATIVE EMBODIMENTS

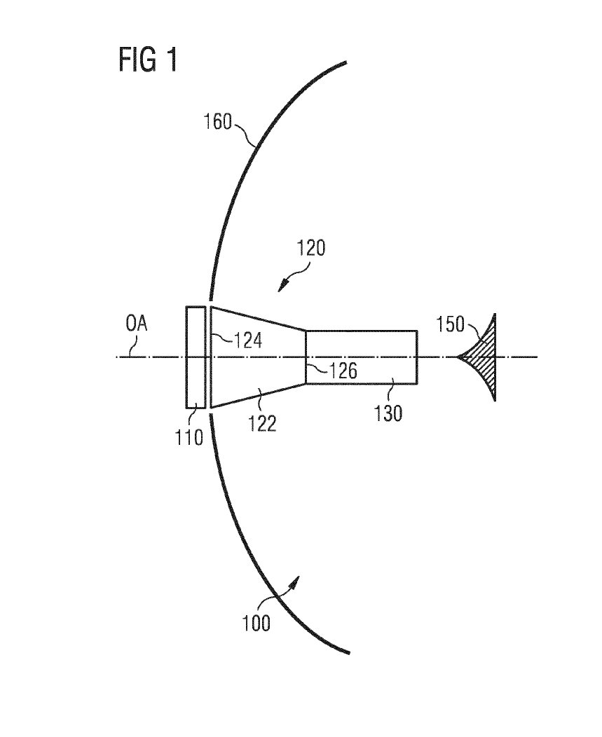

FIG. 1 shows a schematic cross-sectional illustration through a first exemplary embodiment of an illumination unit 100. The illumination unit 100 comprises a surface light source 110 as light-emitting element. An optical axis OA is perpendicular to a light coupling-out area of the surface light source 110 and extends axially symmetrically through the illumination unit 100. A primary optical element 120 is adjacent to the surface light source 110 in the direction of the optical axis OA. The primary optical element contains a conical element 122 having an entrance area 124 and an exit area 126, to which a cylindrical element 130 is adjacent.

The illumination unit 100 comprises a reflector arrangement having a first reflector 150 and a second reflector 160. The first reflector 150 and the second reflector 160 are in each case arranged radially symmetrically about the optical axis, wherein the first reflector 150 is disposed downstream of the primary optical element 120. The second reflector 160 is arranged opposite the first reflector 150 in a ring-shaped manner around the primary optical element 120. The primary optical element 120 projects into the reflector arrangement 140 through an opening in the vertex region of the ring-shaped second reflector 160.

The surface light source 110 can comprise a light-emitting diode (LED) or an organic light-emitting diode (OLED) or a laser diode (LD). The light emitted by the surface light source 110 radiates into the entrance area 124 of the conical element 122. The exit area 126 of the conical element 122 is reduced relative to the entrance area 124 of the conical element 122, as a result of which the luminous area at the exit area 126 is reduced. The cylindrical element 130 is a linear optical waveguide which guides light from the exit area 126 in the direction of the optical axis OA and couples it out upstream of the first reflector 150.

The first reflector 150 completely deflects the light beam emitted from the primary optical element 120 onto the second reflector 160. The second reflector 160 emits the light from the illumination unit 100 in the direction of the optical axis OA at an emission angle of less than 10° FWHM.

By virtue of the arrangement of the surface light source 110 outside the reflector arrangement, it can easily be connected by contact to a heat sink (not illustrated), with the result that the thermal energy of the surface light source 110 can be dissipated, without impeding the optical properties of the illumination unit 100. This arrangement makes it possible to use a surface light source 110 which has large dimensions and which provides a luminous flux comparable with a conventional light source such as, e.g., a halogen incandescent lamp. Via the primary optical element 120, said luminous flux is introduced into the reflector arrangement and is emitted from the latter in the direction of the optical axis at a narrow angle of less than 10° FWHM.

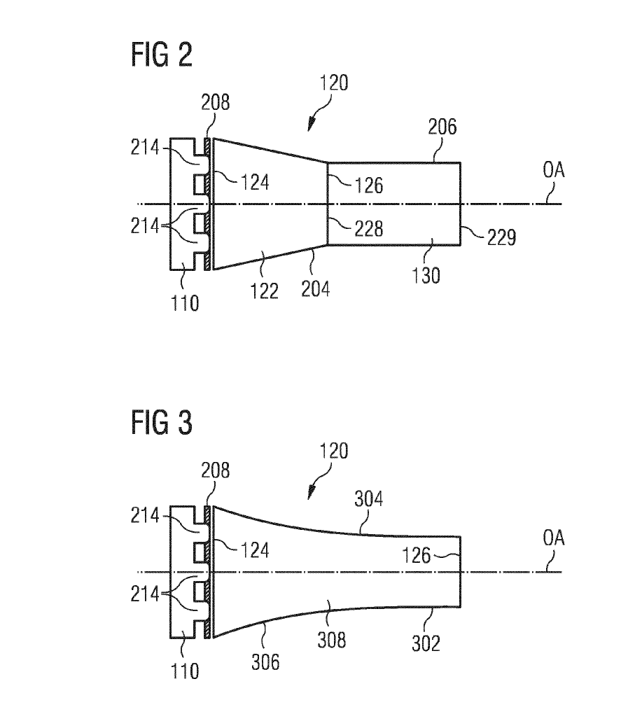

FIG. 2 shows a schematic illustration of the surface light source 110 with the primary optical element 120, such as can be used, for example, in the illumination unit 100 of the first exemplary embodiment. The surface light source 110 comprises a module having a plurality of light-emitting diodes (LEDs) 214. The LEDs 214 can emit in each case white light or single-colored light (red-green-blue). A mixture of white and single-colored LEDs 214 can also be fitted on the module. The spatial emission angle of the LEDs 214 is below 80°. The light emitted by the surface light source 110 couples into the light entrance area 124 of the primary optical element 120. The latter comprises a conical element 122 having a light entrance area 124, a conical side surface 204 and a light exit area 126. The geometry of the light entrance area 124 corresponds to the geometry of the surface light source 110, such that the light emitted by the surface light source 110 at an angle of 80° couples into the entrance area 124.

The conical element 122 has a conical metal strip 204, for example, the inner side of which is reflective or is covered by a reflective layer.

The conical element 122 can also consist of a solid material such as, e.g., glass or plastic having a light entrance area 124, a conical side surface 204 and a light exit area 126, its conical side surface 204 being circumferentially reflectively coated or reflectively fashioned.

A cylindrical optical waveguide 130 is arranged at the light exit area 126 of the conical optical waveguide 122 and guides the light emerging through the exit area 126 linearly in the direction of the first reflector 150. The optical waveguide 130 can be composed of glass such as BK7, for example, or transparent plastics such as polymethyl methacrylate (PMMA or “Plexiglas”), for example. The optical waveguide 130 contains an entrance area 228 and exit area 229 perpendicular to the optical axis OA. A surface unevenness of the entrance area 228 must not exceed a certain amount depending on material. For glass composed of the material BK7, the tangent angle for surface unevennesses is 7.5°. The lateral surface 206 of the linear optical waveguide 130 can be provided with a mirror layer.

A reflective layer 208 is fitted between the surface light source 110 and the light entrance area 124 and reflects the light scattered by the primary optical element back into the primary optical element. The layer 208 can be a diffusely or specularly reflective film, wherein the film contains openings for the LEDs. Alternatively, the layer 208 can contain light-reflecting particles such as, e.g., aluminum oxide powder or titanium oxide powder.

In the case of multicolored LEDs or a mixture of white and multicolored LEDs, the additional reflective layer 208 has an advantageous effect on the color homogeneity, since the light is intermixed better owing to multiple reflections.

In the case of multicolored LEDs or a mixture of white and multicolored LEDs, a faceting of the conical lateral surface 204 has an advantageous effect on the color homogeneity, particularly if the facet size corresponds to the dimensioning of the LEDs.

FIG. 3 shows, in comparison with FIG. 2, an integral embodiment of the primary optical element 120. The primary optical element 120 contains an open optical waveguide tube 302 having an entrance area 124 and an exit area 126, its lateral surface 304 being tapered axially symmetrically along the optical axis OA from the entrance area 124 to the exit area 126. The inner area 306 of the optical waveguide tube is reflective or provided with a reflective layer. The exit area 126 is reduced relative to the entrance area 124, as a result of which the luminous area is reduced at the exit area 126.

The primary optical element 120 can alternatively be a continuous optical waveguide 308, wherein the optical waveguide 308 can consist of glass such as BK7, for example, or transparent plastics such as polymethyl methacrylate (PMMA or “Plexiglas”), for example.

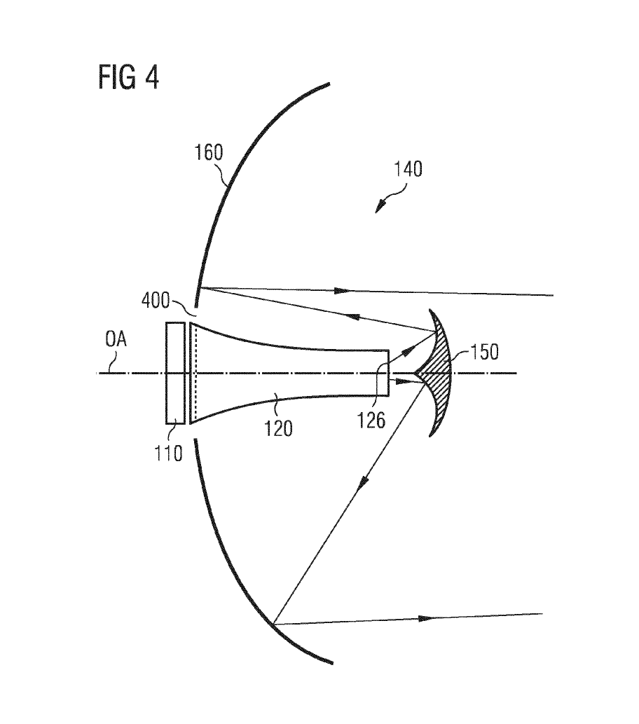

FIG. 4 shows a schematic depiction of the reflector arrangement 140 of the illumination unit 100. The reflector arrangement 140 contains a first reflector 150 and a second reflector 160. The first reflector 150 has the shape of an axicon. The axicon-shaped first reflector 150 is arranged opposite the light exit area 126 of the primary optical element 120 axially symmetrically on the optical axis OA. The light beams emerging from the primary optical element 120 are completely deflected onto the second reflector 160 by the minor geometry of the axicon-shaped first reflector 150, a circular light distribution arising in the region of the second reflector 160. Lateral glare is prevented.

The second reflector 160 has a parabolic shape, in the vertex region of which an opening 400 is provided, through which the primary optical element 120 projects into the reflector arrangement 140. The second reflector 160 guides the light beams past the first reflector 150 in such a way that a circular light distribution is generated in the plane of the first reflector 150. In this case, the internal diameter of the circular disk generated by the light beams in the plane of the first reflector 150 is greater than the external diameter of the first reflector 150. This prevents light losses as a result of shading or scattering at the first reflector 150 or second reflector 160.

The surface of the second reflector 160 can be faceted. A faceting has an advantageous effect on the color mixing, if e.g., the surface light source contains multicolored LEDs or LEDs having different mixed colors.

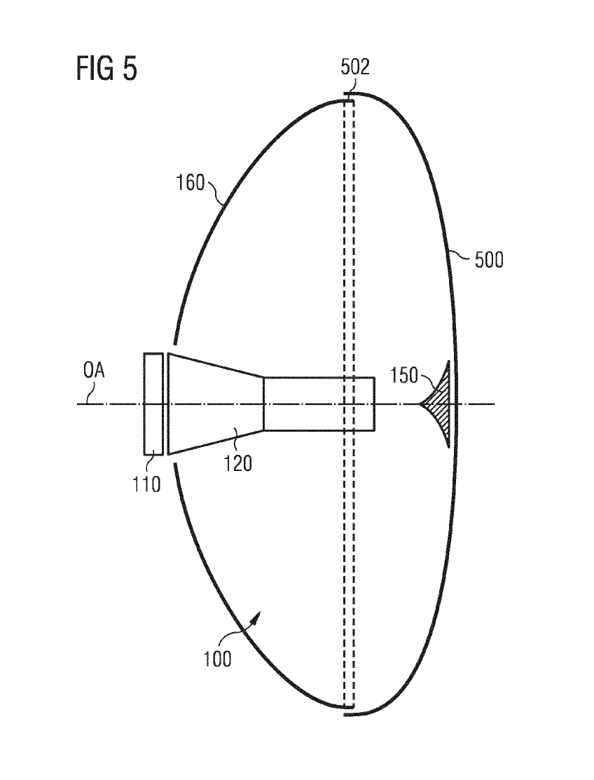

FIG. 5 shows a schematic cross-sectional illustration of a second exemplary embodiment of an illumination unit 100. The illumination unit 100 is identical to that from FIG. 1, with a transparent cover 500 covering the light exit opening of the illumination unit 100. The second reflector 160 contains an outer ring 502, at which the cover 500 is arranged radially symmetrically about the optical axis OA. Said cover encloses the first reflector 150 and adjoins the outer ring 502 of the second reflector 160 in a positively locking manner. The transparent cover can, for example, be screwed on by means of a thread on the edge of the second reflector 160 or be plugged on by means of a snap-action device.

The transparent cover 500 can contain a light-scattering structure having a scattering angle range of 2° to 4° FWHM, for example, which generates a more homogeneous light distribution in the far field of the illumination unit 100. In this case, the transparent cover 500 can comprise a material having a light-scattering structure. Alternatively, the transparent cover 500 can comprise a material having high optical transparency such as glass or Plexiglas, for example, wherein a surface contains a light-scattering structure.

The transparent cover 500 can contain a color-mixing structure, which generates more homogeneous color mixing in the far field of the illumination unit 100. This has an advantageous effect in particular in terms of the color homogeneity, if the surface light source 110 contains light-emitting diodes 214 with multicolored emission or light-emitting diodes with different-colored mixed light such as warm-white or cold-white, for example.

The illumination unit has been described on the basis of some exemplary embodiments in order to illustrate the underlying concept. In this case, the exemplary embodiments are not restricted to specific combinations of features. Even if some features and configurations have been described only in connection with one particular exemplary embodiment or individual exemplary embodiments, they can in each case be combined with other features from other exemplary embodiments. It is likewise possible, in exemplary embodiments, to omit or add individual features presented or particular configurations, insofar as the general technical teaching remains realized.

1-15. (canceled)

16. An illumination unit comprising:
a surface light source;
a primary optical element;
a first reflector; and
a second reflector;
wherein the primary optical element is arranged at the surface light source in such a way that light emitted by the surface light source is imaged onto the first reflector by the primary optical element, a beam cross section of the light being reduced by the primary optical element at the same time; and
wherein the first reflector images the light that has been reduced by the primary optical element onto the second reflector in order to emit the light from the second reflector from the illumination unit.

17. The illumination unit according to claim 16, wherein the surface light source contains a light-emitting semiconductor component or a module comprising a plurality of light-emitting semiconductor components.

18. The illumination unit according to claim 17, wherein the module contains semiconductor components that emit in different colors.

19. The illumination unit according to claim 17, wherein the light-emitting semiconductor component emits into an angle of not more than 80° (FWHM).

20. The illumination unit according to claim 16, wherein the surface light source is arranged outside a reflector arrangement comprising the first reflector and the second reflector.

21. The illumination unit according to claim 16, wherein the primary optical element contains a conical optical waveguide and a light entrance area of the conical optical waveguide is greater than a light exit area.

22. The illumination unit according to claim 21, wherein the light entrance area of the conical optical waveguide is at least double the magnitude of the light exit area.

23. The illumination unit according to claim 22, wherein the light entrance area of the conical optical waveguide is at least nine times the magnitude of the light exit area.

24. The illumination unit according to claim 21, wherein a conical metal strip forms a lateral surface of the conical optical waveguide, an inner side of which is reflective.

25. The illumination unit according to claim 21, wherein the primary optical element contains a cylindrical optical waveguide, which is adjacent to the light exit area of the conical optical waveguide.

26. The illumination unit according to claim 16, wherein the first reflector has an axicon-shaped geometry.

27. The illumination unit according to claim 16, wherein the second reflector has a parabolic geometry.

28. The illumination unit according to claim 16, wherein the second reflector contains an opening in a vertex region, the primary optical element projecting through the opening.

29. The illumination unit according to claim 16, wherein the illumination unit contains a transparent cover, which adjoins an outer edge of the second reflector.

30. The illumination unit according to claim 29, wherein the transparent cover contains a light-scattering structure.

31. The illumination unit according to claim 29, wherein the transparent cover contains a color-mixing structure.
